(19) United States
(12) Patent Application Publication
(10) Pub. No.: US 2012/0269434 A1
(43) Pub. Date: Oct. 25, 2012

(54) Graphic Object Layout Templates for Arranging Images

(76) Inventors: Clayton Brian Atkins, Mountain View, CA (US); Daniel Tretter, San Jose, CA (US); Nic Lyons, Sunnyvale, CA (US)

(21) Appl. No.: 13/501,271

(22) PCT Filed: Oct. 29, 2009
(86) PCT No.: PCT/US09/62501

§ 371 Date: Apr. 11, 2012

(51) Int. Cl. G06K 9/36; G06K 9/34

(52) U.S. Cl. 382/175; 382/284

(57) ABSTRACT

A method for characterizing an arrangement of template regions includes identifying a first bounding box that includes one or more template regions, identifying a second bounding box of one or more template regions that are not in the first bounding box, organizing the first and second bounding boxes into a new bounding box, and designating the new bounding box as the characterized arrangement of template regions.

### BACKGROUND

A drawback of present-day photo-layout solutions that allow a user to generate customized products of composites of photos is the static nature of the available layouts from which the user may choose. In general, these solutions make layout templates available in which each template accommodates photos of a variety of aspect ratios. However, available templates in conventional solutions tend to be concentrated at the lower range of numbers of photos per page. For example, when a user seeks a layout for just a few photographs (such as four), the user may be able to select from a large number of available templates that can accommodate a wide range of aspect ratio distributions; a contemporary solution might offer templates for 4 landscape photos; others for 1 portrait and 3 landscape photos, still others for 2 portrait and 2 landscape photos, and so on. However, as the number of photographs increases (to perhaps six or more) the number of available templates relevant to the user's scenario decreases dramatically, with respect not only to the number of photos but also to the distribution of aspect ratios. Accordingly, in the event that the user would like to place, for example, seven or more photographs into a template, the user may find that only one or two available candidate templates can accommodate exactly this number of images. Further, the available template(s) may require that the photographs have a specific mix of aspect ratios in order for the photographs to fit within the particular template. Thus, it can be said that photo-layout solutions of today leave much to be desired in presenting the user with an acceptable variety of layout templates.

Many present-day solutions make use of automated engines to perform photo layouts that do not require the user to interact directly with the template library. Examples of such automated layout methods include Blocked Recursive Image Composition (BRIC), genetic algorithms, simulated annealing, and others. However, one problem with BRIC, for example, is that although each page may be populated with a varying number of photographs, the shape of the rendered layout of photographs conforms to a rectangular shape. Many users of these layout templates would appreciate the freedom of organizing photo layouts that are not restricted to being purely rectangular in shape and instead possess a greater variety of available shapes. Further, from the perspective of the template designer, additional freedom in organizing photo layouts might allow a particular template developed for one number of photos with a certain aspect ratio distribution, to be reused either for a greater number of photos, or for the same number of photos but a different aspect ratio distribution.

Accordingly, given the existence of only a limited library of templates in which a user can arrange photographs, and given the restrictions on the shape of the layouts that can be generated by automated photo layout software, many users are seeking a solution that mitigates the above-identified shortcomings of present-day photo layout software.

### BRIEF DESCRIPTION OF THE DRAWINGS

FIGS. 1-5 show a sequential template specification process according to an embodiment of the invention.

FIGS. 6a and 6b are tree structures representing the template regions of FIG. 5 according to embodiments of the invention.

FIG. 7 is a flow chart for a method of converting a template specification into a rendered arrangement of photographs according to an embodiment of the invention.

FIG. 8 provides the details of the photo area computation of the candidate tree in accordance with the template specification of step 150 in FIG. 7.

FIG. 9 is a flow chart for a method for generating a distorted dimension table for converting template regions on a canvas into a rendered layout of images according to an embodiment of the invention.

FIGS. 10 and 11 are flowcharts for methods for generating the linear systems of equations used in FIG. 8.

### DESCRIPTION OF APPENDICES

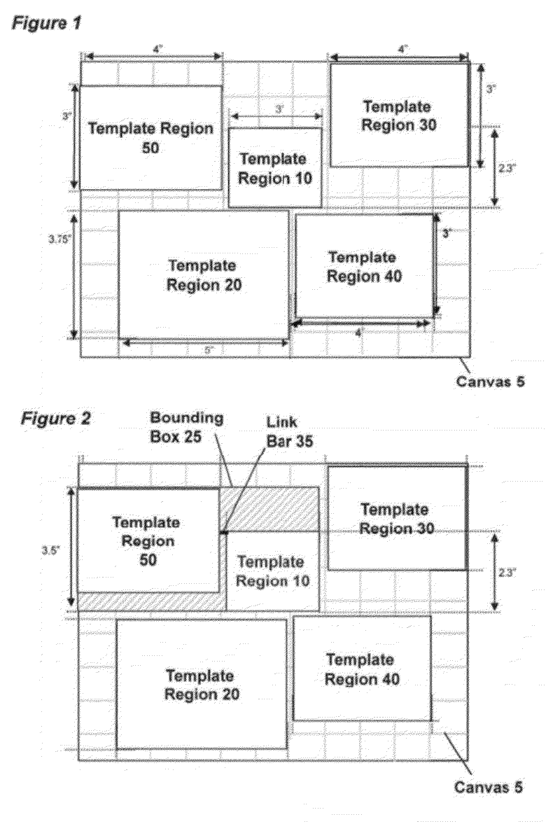

Appendix A is a template specification tree, encoded in XML, that expresses the template regions and bounding boxes captured during the template specification process of FIGS. 1-5 according to an embodiment of the invention.

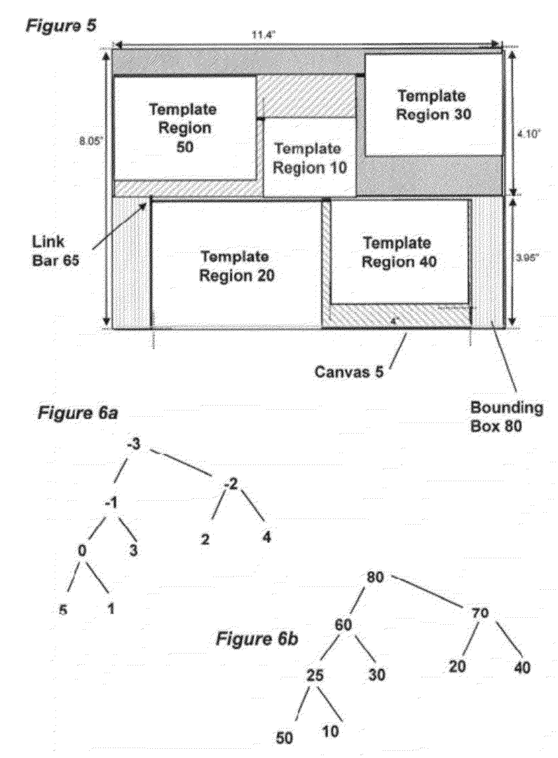

Appendix B is an exemplary distorted dimension table resulting from the template specification given in FIG. 5 according to an embodiment of the invention.

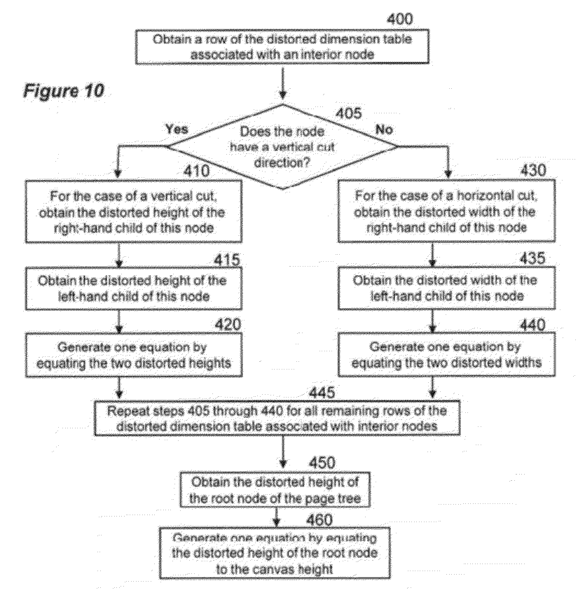

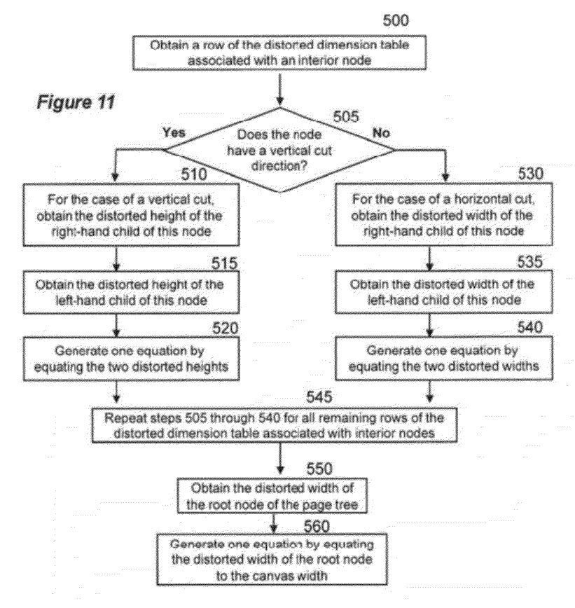

Appendix C includes sample linear systems of equations generated by the methods FIGS. 10 and 11.

### Description of the Embodiments

The inventors contemplate that there are many embodiments of the invention. A first aspect of the invention is the initial encoding (perhaps by a designer) of the template regions present on a canvas. In this first aspect, template regions on the canvas are organized to form an encoded template. In a second aspect of the invention, a user (perhaps at the consumer level) makes use of the encoded template to create photographic layouts. Throughout the specification and claims, the term “photo” and “photograph” is intended to imply an image, photo or photograph stored as a JPEG, bitmap, or other suitable electronic format. Further, the terms “photo” and “photograph” may imply any other type of graphics object that can be stored in an electronic format.

In one embodiment of the invention, a designer begins by selecting two template regions separated by a horizontal or vertical “cut”. In one embodiment of the invention, when selected regions are separated by a horizontal cut, the widths of the two regions are constrained relative to each other. In this embodiment, template regions separated by a vertical cut are constrained in their heights. The first two template regions may be aggregated to form a single block encompassed by a bounding box. The designer may then select the bounding box to be combined with a third template region along a horizontal or vertical cut. The resulting block (which now may include a block in which the first two template regions are combined with the third template region) is then combined with other blocks, each of which includes one or more template regions. By way of this successive aggregation of template regions along horizontal or vertical cuts, the entire set of template regions on a canvas can be organized in a tree structure.

When the designer has created a canvas upon which all of the template regions have been organized and the spatial relationships between the regions properly constrained, an image composition algorithm using the process described in FIG. 6-11 may be used to arrange photographs on the canvas designed by the designer. Accordingly, an image composition algorithm may use (and reuse) the template to evaluate numerous photo layout schemes in which each layout conforms to the design rules specified by the designer. In this embodiment, a template region may be populated with a single photograph or perhaps two or more photographs.

In one embodiment, regions separated by a cut are recognized as being related by way of one or more spatial relationships. These spatial relationships may be characterized as including any combination of the following: the widths of the regions, the heights of the regions, or a point of attachment between the regions. As will be made clear in connection with the description of the template design process, a “region” may be a single template region, or a bounding box that contains multiple template regions.

The generalized method of at least some of the embodiments disclosed herein results in the template designer being able to create nonrectangular layouts of photos on a canvas capable of accommodating any number of photos and any collection of aspect ratios. This results from a level of design freedom not previously available to template designers and also results from image composition methods not previously available to users in need of a template that accommodates a variety of photographs and other graphics objects having various aspect ratios. Thus, the user can create photographic templates that can be rendered according to the user's particular style and taste. In some embodiments of the invention, the image composition method allows multiple images to be placed into a template region that may have been intended by the designer to accommodate only a single image. Thus, in the event that the user has selected a photographic template which can accommodate one large photograph, the design rules of the image composition method may allow several images of varying aspect ratios to be inserted into the template, thus accommodating both portrait- and landscape-rendered images. As a result, the user can be presented with a wide variety of photographic layout options for virtually any number of photographs, even using a template that has been designed to accommodate a small number of images.

In accordance with one embodiment of the invention, FIGS. 1-5 provide the sequence by which template regions are laid out and bound together. Beginning with FIG. 1, an arrangement of template regions on a photo layout canvas is shown. In FIG. 1, a template designer has arranged template regions 10, 20, 30, 40, and 50 on canvas 5. The inventors contemplate that each template region has been selected by way of the designer interacting with a computer program that allocates regions on canvas 5, such as template regions 10, 20, 30, 40, and 50. When the user interacts with the designed template, photographs may be inserted in the template regions. In FIG. 1, the exemplary dimensions of each template region have been identified as well as a background grid pattern to give the designer a notion of the scale of each template region.

FIG. 2, shows the arrangement of photo layout template regions on a canvas according to the embodiment of the invention of FIG. 1. In FIG. 2, bounding box 25 is shown as encompassing template regions 10 and 50. In the embodiment of FIG. 2, bounding box 25 represents the beginning of a “tree” structure that organizes the template regions of canvas 5. Accordingly, as link bar 35 straddles a vertical cut between template regions 10 and 50, the block of template regions 10 and 50 is specified by bounding box 25 that encompasses the two regions. The link bar 35 is attached to the two template regions at attach coordinates that together specify the relative placement of the template regions. In FIG. 2, link bar 35 attaches to template region 50 at a left attach coordinate of approximately 0.4 multiplied by the distance from the top to the bottom of the “eastern” (right) border of template region 50. The opposite side of link bar 35 attaches to a right attach coordinate of 0.0, which corresponds to the top of the “western” (left border) of template region 10. Thus, it can be seen that the left attach coordinate of 0.4 is relative to the eastern border of template region 50, while right attach coordinate of 0.0 is relative to western border of template region 10.

Link bar 35 of FIG. 2 couples template regions 10 and 50 and establishes a relationship between the placement of these regions. In this embodiment, since template regions 10 and 50 are joined along a vertical cut of canvas 5, the heights of template regions 10 and 50 are constrained relative to each other. Thus, when the template is operated upon by way of an image composition algorithm (as will be discussed hereinafter) that inserts photographs into template region 10, the height of template region 50 is constrained to remain proportional to the height of region 10. Thus, in the event that the image composition software inserts a photograph into template region 10 having a “portrait” aspect ratio, the height of template region 50 is constrained to decrease its height proportionally.

Although it is contemplated that in an embodiment of the invention, link bar 35 cuts across a vertical dimension that separates template region 10 from template region 50 and thus constrains the heights of the two template regions to be proportional to each other, in other embodiments of the invention, the two template regions might be constrained in another dimension, such as their widths. In other embodiments, different constraint relationships might be used. For example, the height of one region might be constrained relative to the width of another region. In general, use of a particular constraint relationship is a matter that might be left as a design choice according to the needs of the particular application.

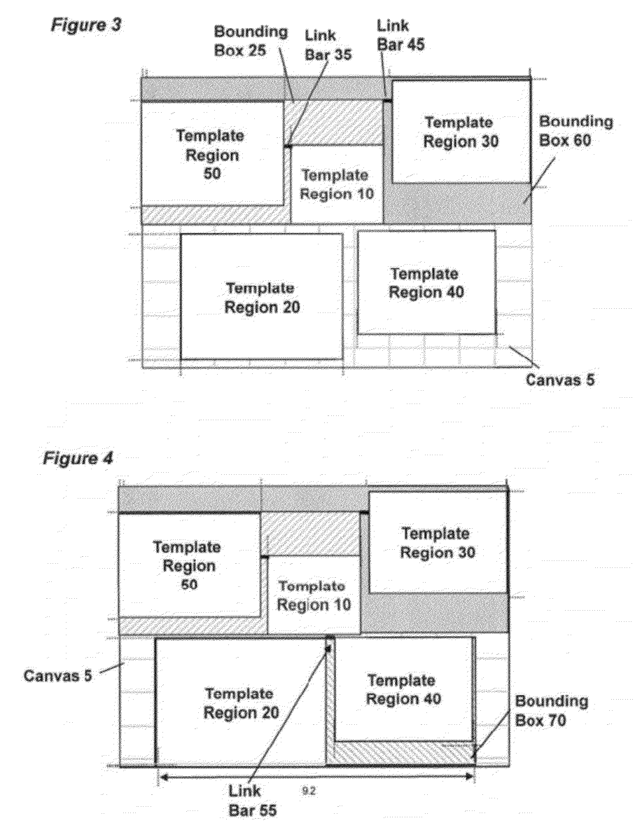

FIG. 3 shows link bar 45 linking bounding box 25 with template region 30 according to an embodiment of the invention. Thus, as bounding box 25 and template region 30 are linked along a vertical cut, the heights of the elements within bounding box 25 and template region 30 are linked in the vertical dimension. Accordingly, as photos are placed within template region 10 (for example) the height of bounding box 25 is constrained to increase or decrease according to the increase (or decrease) of the height of the photo or photos placed within template region 10. In FIG. 3, link bar 45 has been attached to bounding box 25 at the top of the right (eastern) border of the bounding box 25, while the right attach coordinate has been affixed to template region 30 distance of approximately 0.2 times the height as measured from the top to bottom along the western (left) border of template region 30. The resulting bounding box, which includes bounding box 25 as well as template region 30 has been designated as bounding box 60.

FIG. 4 shows link bar 55 as linking template region 20 with template region 40 according to an embodiment of the invention. Bounding box 70 is shown as encompassing template regions 20 and 40 along a vertical cut. Accordingly, as previously mentioned, the two template regions are constrained in height. In FIG. 4, link bar 55 is shown as attaching at 0.0 along the east (right) border of template region 20 and at 0.0 along the west (left) border of template region 40.

FIG. 5 shows link bar 65 joining bounding box 70 with bounding box 60. In FIG. 5, the link from bounding box 70 to bounding box 60 is shown as being an exemplary distance of approximately 0.08 of the distance from the left side to the right side of bounding box 60 along the “southern” (bottom) border of the bounding box. Link bar 65 joins bounding box 70 at a distance of 0.0 times the horizontal distance along the “northern” border from the left to the right of bounding box 70.

Having established the relationship among all of the template regions of canvas 5, the tree structure of FIG. 6a shows the organization of the template regions of FIG. 5 according to embodiments of the inventions. In the tree structure, a convention is used in which the template regions are identified as terminal nodes or “leaves” on the tree, and the interior nodes of the binary tree begin with “0” and count backwards in negative numbers. In the tree structure of FIG. 6a, node “0” represents bounding box 25 which joins template regions 50 and 10. Node “−1” represents bounding box 60, which joins bounding box 25 with template region 30. Node “−2” represents bounding box 70, which joins template region 20 with template region 40. Finally, node “−3” represents the root of the tree structure designated as bounding box 80, in which bounding 70 is joined with bounding box 60. In another embodiment, such as the embodiment of FIG. 6b, the reference designators of FIGS. 1-5 might be used. Although it should be noted that (as will become apparent later) there are advantages to the convention adopted in FIG. 6a over that of FIG. 6b.

In general, for a tree structure with N leaves, it is contemplated that there will be a total of 2N-1 nodes, including interior nodes and terminal nodes. Further, each node might have values in the following fields: value, parent, left-hand child, right-hand child, and cut_direction. In one convention, for the root node, value==parent. The values of the interior nodes are {−(N-2), . . . , −1, 0). The values of the terminal nodes (leaves) are {1, . . . , N}.

In one convention, for interior nodes with horizontal cut directions, the left-hand child is positioned to the “north” of (i.e. above) the right-hand child. For interior nodes with a vertical cut direction, the left child is positioned to the “west” of the right child. Certain proportions of bounding boxes that are siblings (that is, two bounding boxes whose nodes have the same immediate parent in the tree) are specified through their dimensions in the drawing. Specifically, for a parent node having a vertical cut direction, the two child box heights are constrained according to their heights in the drawing; their widths are not constrained. For a parent node having a horizontal cut direction, the two child box widths are constrained according to their widths in the drawing; their heights are not constrained. Finally for interior nodes, the point of attachment is specified using two attachment coordinate values, one for each child. In one convention, for a vertical interior node, the left attachment coordinate relates to a point on the “eastern border” of the left-hand child box, and the right attachment coordinate relates to a point on the “western border” of the right-hand child box. For a horizontal interior node, the left attachment coordinate relates to a point on the “southern border” of the left-hand child box. And the right attachment coordinate relates to a point on the “northern border” of the right-hand child box.

A template design captured using the process described above can be stored for later use. Appendix A is an exemplary template design specification for the exemplary template design described above in connection with FIGS. 1 through 6, encoded using an XML format. Note that in this example, a leaf is regarded as a placeholder for instances in which no other data could be provided. For example, the right-hand child of the node whose value is 5 is referred to as “leaf”, which is merely due to the fact that a leaf does not have a child.

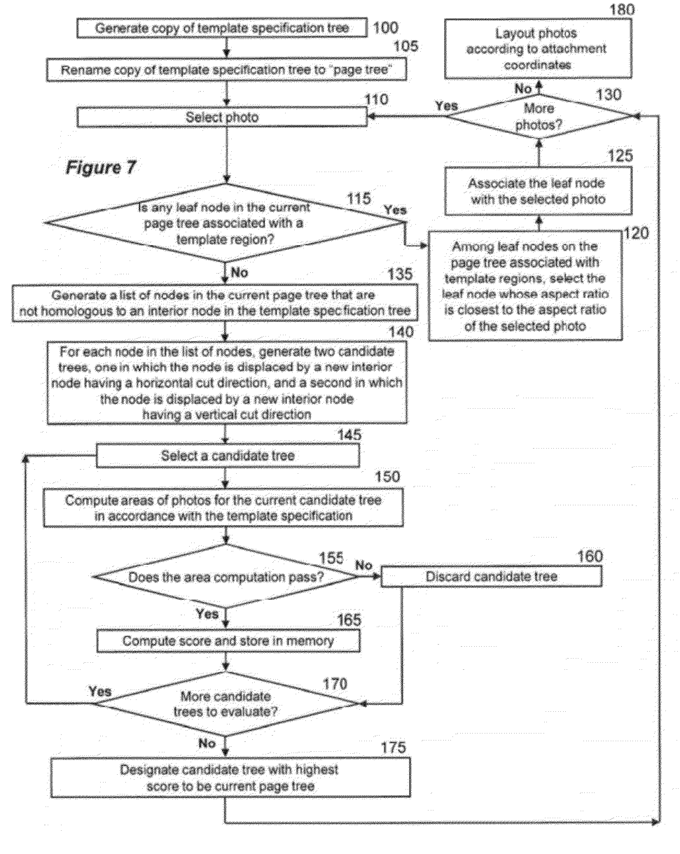

FIG. 7 is a flow chart for a method of using a template specification to generate a rendered layout of photographs according to an embodiment of the invention. FIG. 7 takes as its input a template specification, such as that provided by way of example in Appendix A herein, along with a set of photos. The method of FIG. 7 generates the rendered layout by generating a binary tree. In one embodiment, the template specification is represented using a binary tree whose terminal nodes or “leaves” are associated with template regions. FIG. 7 describes the evolution from the template specification to the actual rendered layout.

It should also be noted that any of the template regions could function as individual BRIG layout regions where multiple photos or other graphic objects may be placed. However, this possibility is not explicitly reflected in the template specification. In fact, the method of FIG. 7 is not restricted to a one-to-one correspondence between the template regions and the photos available for rendering in the layout. Accordingly, the method of FIG. 7 may take as an input fewer photographs than there are template regions, the same number of photographs as there are template regions, or more photographs than there are template regions.

The method of FIG. 7 begins with step 100 in which a copy of the template specification tree is generated. In the embodiment of FIG. 7, the template specification tree is an XML file, such as the XML file of Appendix A. The template specification is copied and the copy is renamed as a “page tree” in step 105. From this point forward, the method of FIG. 7 makes use of the page tree and reserves the original template specification tree for use later in the description. (See FIG. 9, step 315.).

The method FIG. 7 continues at step 110 in which the first photo from a group of photos to be present in the rendered layout is selected. At step 115, a determination is made as to whether any leaf node of the current page tree is associated with a template region. The significance of decision block 115 is that initially, the page tree has just been created by copying the template specification tree; so initially each of the leaf nodes in the current page tree is associated with a template region. In one embodiment, if there are “k” template regions, each of the first “k” photos submitted to the method is associated with a unique template region.

If the decision of step 115 indicates that a leaf node in the current page tree is associated with a template region, step 120 is performed, which includes among leaf nodes on the current page tree associated with template regions, selecting the leaf node whose aspect ratio is closest to the aspect ratio of the selected photo. The method then continues at step 125, which includes associating the selected leaf node with the selected photo. At step 130, a decision is made as to whether or not more photos are present. If indeed more photos are present, the method returns to step 110 and the next photo is selected. Steps 115, 120, 125, and 130 are then repeated until (i) a transition from step 125 to step 130 results in no more photos being available, or (ii) a transition from step 125 to step 130 results in each leaf node in the current page tree being associated with a photo. Note that (i) eventually happens if the number of input photos is less than or equal to the number of template regions in the input template specification; while possibility (ii) eventually happens if the number of input photos is greater than the number of template regions in the input template specification.

When all leaf nodes have been associated with a photo, the decision of step 115 returns a “no” decision. The method then proceeds to step 135, which includes generating a list of nodes in the current page tree that are not “homologous” to an interior node of the specification tree. In the context of FIG. 7, “homologous” implies that just as the template specification dictates how the canvas is to be divided; an individual template region can be divided down in an analogous fashion. Thus, it is possible for the subset of the page tree associated with a template region to possess its own tree that specifies the photo layout rendering within the template region.

The method of FIG. 7 continues at step 140 in which for each node in the list of nodes generated in step 135, two candidate trees are generated. In the first one of the two candidate trees, the node is displaced by a new interior node having a horizontal cut direction. In the second of the two candidate trees, the node is displaced by a new interior node having a vertical cut direction. Thus there are twice as many candidate trees at the outcome of step 140 as there were nodes in the list generated in step 135.

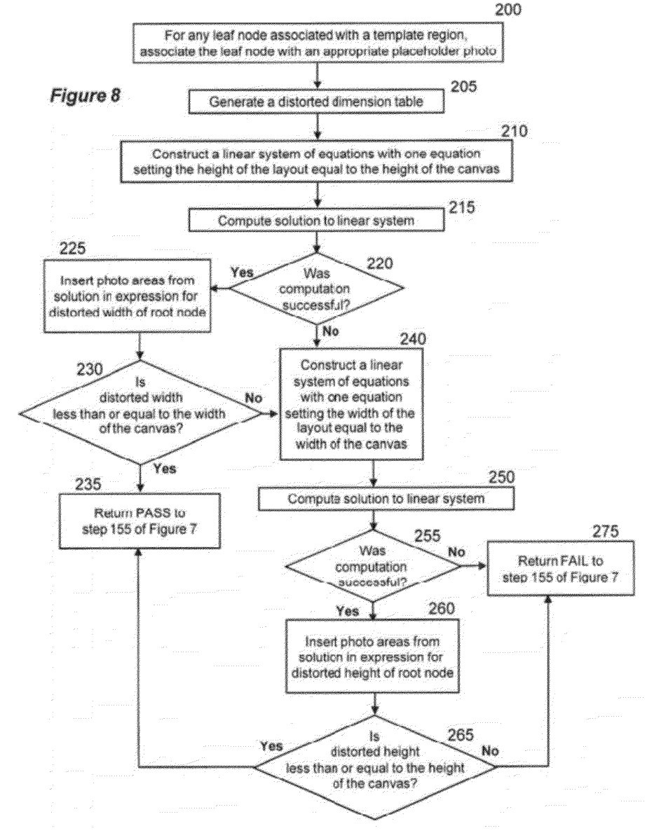

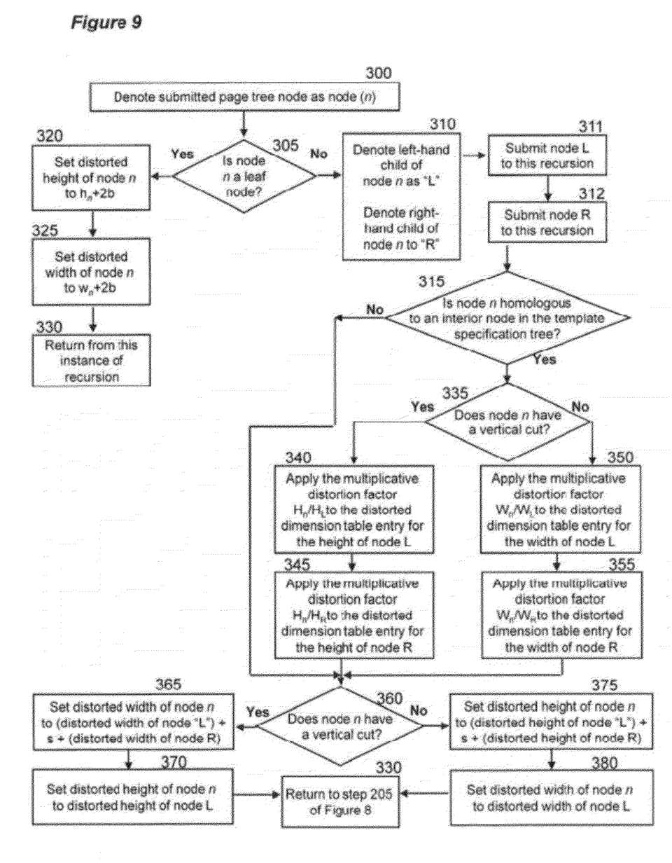

The method continues at step 145 in which the first candidate tree is selected. At step 150, areas of the photos for the current candidate tree are computed in accordance with the template specification. It should be noted that FIGS. 8, 9, 10 and 11 provide further details on the precise manner in which these areas are computed. At the conclusion of step 150, the area computation algorithm returns a PASS (at step 155) if indeed the areas of the photos for the current candidate tree can be computed according to the template specification. If the algorithm does not return a “pass”, that candidate tree is discarded in step 160.

Assuming that the algorithm has returned a PASS, the method continues at step 165 in which a score is assigned to the rendered layout. Any of a number of scoring functions known to those skilled in the art may be used. The scoring function may or may not make use of information from the template specification. One exemplary scoring function is given in C. B. Atkins, “Blocked recursive image composition”, in Proceedings of the 16^{th} ACM international Conference on Multimedia, Vancouver, British Columbia, Canada, Oct. 26-31, 2008. At step 170, a determination is made as to whether there are more candidate trees to evaluate. In the event that there are more candidate trees to evaluate, the method returns to step 145 in which the next candidate tree is selected. In the event that there are no more candidate trees to be evaluated, the method advances to step 175 in which the candidate tree having the highest score is selected and designated as the current page tree. The method then proceeds to step 130 in which a determination is made as to whether there are more photos to be processed. If there are more photos, the method proceeds to step b 110. If there are no more photos to process, the layout having the highest score (assigned in step 165) is rendered in step 180. To render the layout, the photo areas computed in step 150 for the corresponding candidate tree are used. Determining photo positions is straightforward given the photo areas along with the attachment coordinates from the template specification.

FIG. 8 provides the details of the photo area computation of the candidate tree in accordance with the template specification of step 150 in FIG. 7. The method begins at step 200, which associates a placeholder to any leaf node that is associated with a template region. The purpose of step 200 is primarily to address the condition of having fewer photos in the current candidate tree, than template regions in the template specification. As an example, assume the template specification includes five regions in which photos can be laid out. Assume also that the current candidate tree includes only three photos. To address this condition, the method records the aspect ratios of the unassigned template regions and allocates a placeholder to those regions. In this manner, step 200 regards the empty template region as having a photo assigned to the region in which the photo is of the same aspect ratio as the empty template region.

The method continues with step 205 in which a distorted dimension table is generated. The details of step 205 have been included in the description of FIG. 9 of this specification. The purpose of the distorted dimension table is to impose proportions from the template specification onto the layout corresponding to the current candidate tree. Constraining two distorted heights to be equal is equivalent to constraining the corresponding undistorted heights to be as prescribed by the template specification; and similarly for widths. As an example, in FIG. 2, template region 50 is shown as being 3.0 inches in height. Additionally, template region 10 is shown as being 2.3 inches in height. Finally, bounding box 25 is shown as being 3.5 inches in height. In the distorted dimension table, at the level of node 0, the height of template region 50 is distorted by an amount equal to 3.5/3.0, and the height of template region 10 is distorted by an amount equal to 3.5/2.3. A complementary distortion is also performed in the width dimension. An exemplary distorted dimension table has been included in Appendix B.

After the distorted dimension table has been generated, step 210 is performed, which includes constructing a linear system of equations with one equation setting the distorted height of the layout equal to the height of the canvas (such as canvas 5 of FIGS. 1-5). Each of the other equations in this linear system constrains a distorted dimension of one bounding box in the layout corresponding to a first node in the current candidate tree, to be equal to a corresponding distorted dimension of another bounding box in the layout corresponding to a second node in the current candidate tree that is the sibling of the first node. In one embodiment, the variables in this linear system are the widths of the photos. The photo aspect ratio is defined as the photo height divided by the photo width. In one embodiment, photo aspect ratios are regarded as fixed, so that the height can be written as the product of the aspect ratio times the width. The details of step 210 have been included in the description of FIG. 10 of this specification.

At step 215, an attempt is made to compute the solution to the set of linear equations. In many embodiments, this step entails the inversion of the square matrix A in the expression Ax=b. At step 220, a determination is made as to whether the linear system of equations can be solved. The purpose of step 220 is to recognize the possibility that the system of equations Ax=b may be “ill-conditioned”. In the event that the solution to the linear system of equations cannot be computed, perhaps due to the system being ill-conditioned, the method proceeds to step 240 in which a second linear system of equations is constructed. The second system of linear equations is the same as the first system of linear equations from step 210, except the equation setting the distorted height of the layout to the height of the canvas is replaced with an equation setting the distorted width of the layout equal to the width of the canvas. At step 250, an attempt is made to compute the solution to the second system of linear equations.

Returning now to step 220, in the event that the first set of linear equations (in which one equation sets the height of the layout equal to the height of the canvas) can be solved, step 225 is performed in which photo areas implied by the solution are inserted into the expression for the distorted width of the root node. The method proceeds to step 230 in which a decision is made as to whether the distorted width is less than or equal to the width of the canvas. If the distorted width is not less than or equal to the width of the canvas (indicating that the resulting rendered photo layout is likely to have a width too large to be accommodated by the canvas) the method proceeds to step 240. In step 240 (as previously mentioned) a second linear system of equations is constructed in which one equation sets the width of the layout equal to the width of the canvas. The details of step 210 have been included in the description of FIG. 11 of this specification. Returning to the decision of step 230, if this step indicates that the distorted width is indeed less than or equal to the width of the canvas, step 235 is performed in which a PASS is returned to step 155 of FIG. 7.

Returning now to step 255, in the event that the computation of the second linear system of equations is successful, step 260 is performed in which the photo areas from the solution are inserted into, the expression for the distorted height of the root node. Step 265 is then performed in which a decision is made as to whether the distorted height is less than or equal to the height of the canvas. In the event that the distorted height is not less than or equal to the height of the canvas (indicating that the resulting rendered photo layout is likely to have a height too large to be accommodated by the canvas) the method proceeds to step 275 in which a FAIL is returned to step 155 of FIG. 7. Step 275 is also performed in the event that the decision of step 255 indicates that the computation of the second system of linear equations has not been successful (perhaps due to an ill-conditioned set of equations).

In the event that step 265 indicates that the distorted height is indeed less than or equal to the height of the canvas, the method proceeds to step 235 in which a PASS is returned to step 155 of FIG. 7.

Returning to FIG. 8, step 205, the process to generate the distorted dimension table proceeds by submitting the root node of the page tree to the recursive function of FIG. 9. Using the page tree of FIG. 6a to illustrate the example of FIG. 9, the method begins at step 300 in which the root node of the page tree is submitted to the recursion function. In this first introduction of the page tree to the recursion function, the root node (n) assumes the value of −3 as shown in FIG. 6a. The method continues at step 305 in which a decision is made as to whether the node n is a leaf node.

In an example, consider first the case where node n is a leaf node. The method continues to step 320, where the distorted height of node n is set to an initial value of hₙ+2b, where hₙ is the variable for the height of the photo associated with node n, and b denotes the prescribed thickness of a border to be reserved around photo perimeters. In one embodiment, b is a constant greater than or equal to zero. The method then continues to step 325, where the distorted width of node n is set to an initial value of wₙ+2b, where wₙ is the variable for the width of the photo associated with node n. The method then moves to step 330, at which point the method terminates the current recursion instance, and returns to the process that invoked the recursion instance that was just terminated.

Returning to step 305, consider now the case where node n is not a leaf node. The method proceeds to step 310 in which “L” is set to equal the index of the left-hand child of node n (that is, −3), and “R” is set equal to the index of the right-hand child of the node n=−3. Thus, at the completion of step 310, node L=−1, and node R=−2.

The method then proceeds to step 311 where node L is submitted to the recursion of FIG. 9. When this happens, the instance of the recursion of FIG. 9 in which n=−3 is placed “on hold”, while node L=−1 is submitted to step 300 in a new instance of the recursion. The form of this recursion, known as a “depth-first” search, taken together with the form of the page tree and the fact that the page tree has finite depth, imply that process control will return from the recursion. At such time the current instance of FIG. 9, in which n=−3, resumes using the arguments of the previous instance of the recursion.

The method then proceeds to step 312 where node R is submitted to the recursion of FIG. 9. In the same fashion as described above in connection with step 311, process control will return from the recursion; and at such time the current instance of FIG. 9, in which n=−3, resumes using the arguments of the previous instance of the recursion.

The method proceeds to step 315 in which a decision is made as to whether node n is homologous to an interior node of the template specification tree. (An unmodified copy of the template specification tree was retained in step 100 of FIG. 7. The advantage of retaining an intact copy of the template specification tree, at least in this embodiment, enables the method to compare the node currently being processed with the nodes of the template specification. The template specification interior nodes provide the fractions that appear in the distorted dimension table.)

In the event that the decision of step 315 indicates that node n is not homologous to an interior node of the template specification tree, the method proceeds to step 360 which is described below.

In the event that the decision of step 315 indicates that node n is homologous to an interior node of the template specification tree, the method proceeds to step 335 in which a determination is made as to whether node n includes a vertical cut.

Referring to step 335, if node n includes a vertical cut, step 340 is performed in which the multiplicative distortion factor of Hₙ/H_{L} is applied to the distorted dimension table entry for the height of node labeled “L” in this instance of the recursion. The method proceeds to step 345 in which the multiplicative distortion factor Hₙ/H_{R} is applied to the distorted dimension table entry for the height of node labeled “R” in this instance of the recursion. The method then proceeds to step 360 which is described below.

Returning to step 335, if node n does not include a vertical cut, step 350 is performed in which the multiplicative distortion factor of Wₙ/W_{L} is applied to the distorted dimension table entry for the width of node labeled “L” in this instance of the recursion. The method proceeds to step 355 in which the multiplicative distortion factor Wₙ/W_{R} is applied to the distorted dimension table entry for the width of node labeled “R” in this instance of the recursion. The method then proceeds to step 360.

At step 360 a decision is made as to whether or not the node n includes a vertical cut. If the node n does include a vertical cut, step 365 is performed in which the distorted width of node n is initially set to the following expression: (current expression for distorted width of node labeled “L”)+s+(current expression for distorted width of node labeled “R”). In this expression, the quantity “s” equals the prescribed spacing between adjacent bounding boxes. (In most embodiments, it is contemplated that “s” is a small positive number or zero.) The method then proceeds to step 370 in which the distorted height of node n is initially set to the following expression: (current expression for distorted height of node labeled “L”). The method then moves to step 330, at which point the method terminates the current recursion instance, and returns to the process that invoked the recursion instance that was just terminated.

Returning to step 360, if the node n does not include a vertical cut, step 375 is performed in which the distorted height of node n is initially set to the following expression: (current expression for distorted height of node labeled “L”)+s+(current expression for distorted height of node labeled “R”). The method then proceeds to step 380 in which the distorted width of node n is initially set to the following expression: (expression for distorted width of node labeled “L”). The method then moves to step 330, at which point the method terminates the current recursion instance, and returns to the process that invoked the recursion instance that was just terminated.

When the method of FIGS. 7, 8, and 9 are applied to the template specification shown in FIG. 5, using the node values shown in FIG. 6a, the distorted dimension table of Appendix B results. In the distorted dimension table, the quantities identified by capital letters (such as H₀ and W₋₁) are dimensions of the template regions and bounding boxes shown in FIG. 5. These dimension values are obtained directly from the template specification. The quantities identified in lowercase (such as h₅ and w₅) are the unknowns that comprise the variables in the system of linear equations to be solved, which will be discussed herein.

FIG. 10 is a flowchart for a method of constructing a linear system of equations with one equation setting the height of the layout equal to the height of the canvas according to an embodiment of the invention. The method begins at step 400 in which a row of the distorted dimension table associated with an interior node is obtained. Next, in step 405, a decision is made as to whether the node has a vertical cut direction. If the decision of step 405 indicates that the node has a vertical cut, the distorted height of the right hand child of the node is obtained in step 410 from the distorted dimension table (such as the distorted dimension table of Appendix B herein). In a similar manner, at step 415, the distorted height of the left hand child of this node is obtained. The method of FIG. 10 continues at step 420 in which a single equation is generated by equating the two distorted heights from steps 410 and 415. The method then moves to step 445 which is described below.

Returning to step 405, in the event that the node does not have a vertical cut direction, the method proceeds to step 430 for the case of a horizontal cut. At step 430, the distorted width of the right-hand child for this node is obtained from the distorted dimension table, such as the distorted dimension table of Appendix B herein. In a similar manner, at step 435 the distorted width of the left-hand child of this node is obtained. The method continues at step 440 in which a single equation is generated by equating the two distorted widths from steps 430 and 435. The method then moves to step 445.

In step 445, steps 405 through 440 are repeated for all remaining rows of the distorted dimension table associated with interior nodes. After completing step 445, there are N-1 linear equations where N is the number of terminal nodes in the current page tree.

The method continues at step 450 in which the distorted height of the root node of the page tree is obtained. At step 460, one equation is generated by equating the distorted height of the root node to the canvas height. By following the method of FIG. 10, the linear system of equations shown at the first portion of Appendix C is obtained.

FIG. 11 is similar to FIG. 10, with the exception of the final two steps. In step 550 the distorted width of the root node of the page tree is obtained. At step 560, one equation is generated by equating the distorted width of the root node to the canvas width. By following the method of FIG. 11, the linear system of equations shown at the latter portion of Appendix C is obtained

The method of FIG. 11 begins at step 500 in which a row of the distorted dimension table associated with an interior node is obtained. Next, in step 505, a decision is made as to whether the node has a vertical cut direction. If the decision of step 505 indicates that the node has a vertical cut, the distorted height of the right hand child of the node is obtained in step 510 from the distorted dimension table (such as the distorted dimension table of Appendix B herein). In a similar manner, at step 515, the distorted height of the left hand child of this node is obtained. The method of FIG. 10 continues at step 520 in which a single equation is generated by equating the two distorted heights from steps 510 and 515. The method then moves to step 545 which is described below.

Returning to step 505 (as referenced in step 545), in the event that the node does not have a vertical cut direction, the method proceeds to step 530 for the case of a horizontal cut. At step 530, the distorted width of the right-hand child for this node is obtained from the distorted dimension table, such as the distorted dimension table of Appendix B herein. In a similar manner, at step 535 the distorted width of the left-hand child of this node is obtained. The method continues at step 540 in which a single equation is generated by equating the two distorted widths from steps 530 and 535. The method then moves to step 545.

In step 545, steps 505 through 540 are repeated for all remaining rows of the distorted dimension table associated with interior nodes. After completing step 545, there are N-1 linear equations where N is the number of terminal nodes in the current page tree.

The method continues at step 550 in which the distorted height of the root node of the page tree is obtained. At step 560, one equation is generated by equating the distorted height of the root node to the canvas height. By following the method of FIG. 11, the linear system of equations shown at the latter portion of Appendix C is obtained.

In conclusion, while the present invention has been particularly shown and described with reference to various embodiments, those skilled in the art will understand that many variations may be made therein without departing from the spirit and scope of the invention as defined in the following claims. This description of the invention should be understood to include the novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding 2 or more such elements.

### Appendix A

This Appendix includes an XML listing for the arrangement of template regions and bounding boxes captured during the template specification process of FIGS. 1-5.

APPENDIX A
XML-encoded template
specification tree

```
<template_graph>
  <template_graph_node>
  <value> −3 </value>
  <parent> −3 </parent>
  <Lchild> −1 </Lchild>
  <Rchild> −2 </Rchild>
  <cut_dir> HORIZ </cut_dir>
  <height> 8.049999 </height>
  <width> 11.4 </width>
  <left_attach_coord> 0.079 </left_attach_coord>
  <right_attach_coord> 0 </right_attach_coord>
  </template_graph_node>
  <template_graph_node>
  <value> −2 </value>
  <parent> −3 </parent>
  <Lchild> 2 </Lchild>
  <Rchild> 4 </Rchild>
  <cut_dir> VERT </cut_dir>
  <height> 3.75 </height>
  <width> 9.200001 </width>
  <left_attach_coord> 0 </left_attach_coord>
  <right_attach_coord> 0 </right_attach_coord>
  </template_graph_node>
  <template_graph_node>
  <value> −1 </value>
  <parent> −3 </parent>
  <Lchild> 0 </Lchild>
  <Rchild> 3 </Rchild>
  <cut_dir> VERT </cut_dir>
  <height> 4.1 </height>
  <width> 11.4 </width>
  <left_attach_coord> 0 </left_attach_coord>
  <right_attach_coord> 0.2 </right_attach_coord>
  </template_graph_node>
  <template_graph_node>
  <value> 0 </value>
  <parent> −1 </parent>
  <Lchild> 5 </Lchild>
  <Rchild> 1 </Rchild>
  <cut_dir> VERT </cut_dir>
  <height> 3.5 </height>
  <width> 7.199999 </width>
  <left_attach_coord> 0.4 </left_attach_coord>
  <right_attach_coord> 0 </right_attach_coord>
  </template_graph_node>
  <template_graph_node>
  <value> 1 </value>
  <parent> 0 </parent>
  <Lchild> LEAF </Lchild>
  <Rchild> LEAF </Rchild>
  <cut_dir> LEAF </cut_dir>
  <height> 2.3 </height>
  <width> 3 </width>
  <left_attach_coord> LEAF </left_attach_coord>
  <right_attach_coord> LEAF </right_attach_coord>
  </template_graph_node>
  <template_graph_node>
  <value> 2 </value>
  <parent> −2 </parent>
  <Lchild> LEAF </Lchild>
  <Rchild> LEAF </Rchild>
  <cut_dir> LEAF </cut_dir>
  <height> 3.75 </height>
  <width> 5 </width>
  <left_attach_coord> LEAF </left_attach_coord>
  <right_attach_coord> LEAF </right_attach_coord>
  </template_graph_node>
  <template_graph_node>
  <value> 3 </value>
  <parent> −1 </parent>
  <Lchild> LEAF </Lchild>
  <Rchild> LEAF </Rchild>
  <cut_dir> LEAF </cut_dir>
  <height> 3 </height>
  <width> 4 </width>
  <left_attach_coord> LEAF </left_attach_coord>
  <right_attach_coord> LEAF </right_attach_coord>
  </template_graph_node>
  <template_graph_node>
  <value> 4 </value>
  <parent> −2 </parent>
  <Lchild> LEAF </Lchild>
  <Rchild> LEAF </Rchild>
  <cut_dir> LEAF </cut_dir>
  <height> 3 </height>
  <width> 4 </width>
  <left_attach_coord> LEAF </left_attach_coord>
  <right_attach_coord> LEAF </right_attach_coord>
  </template_graph_node>
  <template_graph_node>
  <value> 5 </value>
  <parent> 0 </parent>
  <Lchild> LEAF </Lchild>
  <Rchild> LEAF </Rchild>
  <cut_dir> LEAF </cut_dir>
  <height> 3 </height>
  <width> 4 </width>
  <left_attach_coord> LEAF </left_attach_coord>
  <right_attach_coord> LEAF </right_attach_coord>
  </template_graph_node>
</template_graph>
```

APPENDIX B
Distorted Dimensions for Template Specification of FIG. 5:

| Node | | |
|---|---|---|
| index | Distorted height | Distorted width |
| 5 | $\frac{{H}_{0}}{{H}_{5}} ( {h}_{5} + 2 b )$ | (w₅ + 2b) |
| 1 | $\frac{{H}_{0}}{{H}_{1}} ( {h}_{1} + 2 b )$ | (w₁ + 2b) |
| 0 | $\frac{{H}_{- 1}}{{H}_{0}} \frac{{H}_{0}}{{H}_{5}} ( {h}_{5} + 2 b )$ | (w₅ + 2b) + s + (w₁ + 2b) |
| 3 | $\frac{{H}_{- 1}}{{H}_{3}} ( {h}_{3} + 2 b )$ | (w₃ + 2b) |
| −1 | $\frac{{H}_{- 1}}{{H}_{0}} \frac{{H}_{0}}{{H}_{5}} ( {h}_{5} + 2 b )$ | $\frac{{W}_{- 3}}{{W}_{- 1}} ( ( {w}_{5} + 2 b ) + s + ( {w}_{1} + 2 b ) + s + ( {w}_{3} + 2 b ) )$ |
| 2 | $\frac{{H}_{- 2}}{{H}_{2}} ( {h}_{2} + 2 b )$ | (w₂ + 2b) |
| 4 | $\frac{{H}_{- 2}}{{H}_{4}} ( {h}_{4} + 2 b )$ | (w₄ + 2b) |
| −2 | $\frac{{H}_{- 2}}{{H}_{2}} ( {h}_{2} + 2 b )$ | $\frac{{W}_{- 3}}{{W}_{- 2}} ( ( {w}_{2} + 2 b ) + s + ( {w}_{4} + 2 b ) )$ |
| −3 | $\frac{{H}_{- 1}}{{H}_{0}} \frac{{H}_{0}}{{H}_{5}} ( {h}_{5} + 2 b ) + s + \frac{{H}_{- 2}}{{H}_{2}} ( {h}_{2} + 2 b )$ | $\frac{{W}_{- 3}}{{W}_{- 1}} ( ( {w}_{5} + 2 b ) + s + ( {w}_{1} + 2 b ) + s + ( {w}_{3} + 2 b ) )$ |

H_{N} = Height of box N from template specification. (See page B-2 for values.)
W_{N} = “width of box N from template specification” (See page B-2 for values.)
hₙ = “height of image n” . . . a variable; this is equivalent to aₙwₙ where aₙ is aspect ratio of image n.
wₙ = “width of image n” . . . a variable − to be solved for in system of linear equations
b = the prescribed thickness of a border around the perimeter of each photo; in general we expect this to be positive or zero. The extension to each photo having a unique border thickness is in accordance with conventional BRIC techniques.
s = the prescribed space between adjacent bounding boxes. The inventors contemplate that this value will either be a small positive value or zero.
From the dimensions of the template regions and bounding boxes of FIGS. 1-5,
H₀ = 3.5 inches
H₁ = 2.3 inches
H₂ = 3.75 inches
H₃ = 3.0 inches
H₄ = 3.0 inches
H₅ = 3.0 inches
H₋₂ = 3.95 inches
H₋₁ = 4.1 inches
W₋₁ = 7.2 inches
W₋₂ = 11.4 inches
W₋₃ = 9.2 inches

$$Appendix C \text{-} Linear system of equations resulting from method of Figures 10 and 11$$

$$Equataions resulting from method of Figure 10 \text{:}$$

$$\frac{{H}_{0}}{{H}_{5}} ( {h}_{5} + 2 b ) = \frac{{H}_{0}}{{H}_{1}} ( {h}_{1} + 2 b )$$

$$\frac{{H}_{- 1}}{{H}_{0}} \frac{{H}_{0}}{{H}_{5}} ( {h}_{5} + 2 b ) = \frac{{H}_{- 1}}{{H}_{3}} ( {h}_{3} + 2 b )$$

$$\frac{{H}_{- 2}}{{H}_{2}} ( {h}_{2} + 2 b ) = \frac{{H}_{- 2}}{{H}_{4}} ( {h}_{4} + 2 b )$$

$$\frac{{W}_{- 3}}{{W}_{- 1}} ( ( {w}_{5} + 2 b ) + s + ( {w}_{1} + 2 b ) + s + ( {w}_{3} + 2 b ) ) = \frac{{W}_{- 3}}{{W}_{- 2}} ( ( {w}_{2} + 2 b ) + s + ( {w}_{4} + 2 b ) )$$

$$\frac{{H}_{- 1}}{{H}_{0}} \frac{{H}_{0}}{{H}_{5}} ( {h}_{5} + 2 b ) + s + \frac{{H}_{- 2}}{{H}_{2}} ( {h}_{2} + 2 b ) = height of canvas$$

$$Equations resulting from method of Figure 11 \text{:}$$

$$\frac{{H}_{0}}{{H}_{5}} ( {h}_{5} + 2 b ) = \frac{{H}_{0}}{{H}_{1}} ( {h}_{1} + 2 b )$$

$$\frac{{H}_{- 1}}{{H}_{0}} \frac{{H}_{0}}{{H}_{5}} ( {h}_{5} + 2 b ) = \frac{{H}_{- 1}}{{H}_{3}} ( {h}_{3} + 2 b )$$

$$\frac{{H}_{- 2}}{{H}_{2}} ( {h}_{2} + 2 b ) = \frac{{H}_{- 2}}{{H}_{4}} ( {h}_{4} + 2 b )$$

$$\frac{{W}_{- 3}}{{W}_{- 1}} ( ( {w}_{5} + 2 b ) + s + ( {w}_{1} + 2 b ) + s + ( {w}_{3} + 2 b ) ) = \frac{{W}_{- 3}}{{W}_{- 2}} ( ( {w}_{2} + 2 b ) + s + ( {w}_{4} + 2 b ) )$$

$$\frac{{W}_{- 3}}{{W}_{- 1}} ( ( {w}_{5} + 2 b ) + s + ( {w}_{1} + 2 b ) + s + ( {w}_{3} + 2 b ) ) = width of canvas$$

What is claimed is:

1. A method for characterizing an arrangement of template regions comprising:
identifying a first bounding box that includes one or more template regions;
identifying a second bounding box of one or more template regions that are not in the first bounding box;
organizing the first and second bounding boxes into a new bounding box; and
designating the new bounding box as the characterized arrangement of template regions.

2. The method of claim 1, wherein the step of organizing includes determining a cut that separates the identified first and second bounding boxes.

3. The method of claim 2, wherein the cut is one of either a horizontal or a vertical cut.

4. The method of claim 1, wherein the new bounding box includes the identified first and second bounding boxes and a point of attachment between the identified first and second bounding boxes.

5. The method of claim 1 wherein the identified first bounding box contains only a first template region and the identified second bounding box contains only a second template region.

6. The method of claim 1, wherein one of the identified first and second bounding boxes is determined by:
identifying a third bounding box that includes one or more template regions;
identifying a fourth bounding box of one or more template regions that are not in the third bounding box; and
organizing the third and fourth bounding boxes into the one of the identified first and second bounding boxes.

7. The method of claim 6, wherein the other of the identified first and second bounding boxes is determined by:
identifying a fifth bounding box that includes one or more template regions;
identifying a sixth bounding box of one or more template regions that are not in the fifth bounding box; and
organizing the fifth and sixth bounding boxes into the other of the identified first and second bounding boxes.

8. The method of claim 6 wherein the other of the identified first and second bounding boxes contains only one template region.

9. A method for arranging photographs according to template regions in a template specification, comprising:
reading in the template specification;
associating a first one of the photographs with a first template region;
associating a second one of the photographs with a second template region; and
determining an arrangement of the photographs based on a spatial relationship in the template specification.

10. The method of claim 9, wherein the step of determining the arrangement includes determining areas of the photographs.

11. The method of claim 10, wherein the spatial relationship includes the constraint that when the first and second template regions are separated by a horizontal cut, the first and second photographs are related in width.

12. The method of claim 11, wherein the constraint is further based at least in part on the widths of the first and second template regions.

13. The method of claim 9, wherein the spatial relationship includes the constraint that when the first and second template regions are separated by a vertical cut, the first and second photographs are related in height.

14. The method of claim in 13, wherein the constraint is further based at least in part on the heights of the first and second template regions.

15. The method of claim 9 wherein the spatial relationship includes a point of attachment between the first template region and the second template region.
